(19) United States
(12) Patent Application Publication
(10) Pub. No.: US 2019/0084326 A1
(43) Pub. Date: Mar. 21, 2019

(54) Printed Frame Image on Artwork

(71) Applicant: Kamran Deljou, Atlanta, GA (US)

(72) Inventor: Kamran Deljou, Atlanta, GA (US)

(73) Assignee: Roya Deljou, Atlanta, GA (US)

(21) Appl. No.: 16/122,260

(22) Filed: Sep. 5, 2018

Related U.S. Application Data
(60) Provisional application No. 62/559,092, filed on Sep. 15, 2017.

(51) Int. Cl. B41J 29/38; A47G 1/06

(52) U.S. Cl. CPC B41J 29/38; A47G 1/06

(57) ABSTRACT

In a method of generating a print, an image of at least one work of art is scanned, thereby generating an artwork digital image. An image of at least one frame molding is scanned, thereby generating a molding digital image. An image of at least one matte is scanned, thereby generating a matte digital image. The artwork digital image, either scanned, imported or sourced from elsewhere, is combined with the molding digital image, and/or mat digital image, either scanned, imported, or sourced from elsewhere, thereby generating a combined image of the work of art surrounded by a frame made of the molding and/or matte. The combined image is printed onto a substrate. A system for generating printed artwork includes a scanner that is configured to scan works of art, mattes and moldings. A computer combines a digital artwork image with a digital molding and/or matte image, thereby generating a combined digital image that include an image of one of the works of art surrounded by an image of a frame made from one or multiple moldings and/or mattes. A printer prints the combined digital image onto a selected substrate.

### CROSS-REFERENCE TO RELATED APPLICATION(S)

This application claims the benefit of U.S. Provisional Patent Application Ser. No. 62/559,092, filed Sep. 15, 2017, the entirety of which is hereby incorporated herein by reference.

### BACKGROUND OF THE INVENTION

### 1. Field of the Invention

The present invention relates to art production processes and, more specifically, to a system for adding images of frames to printed artwork.

### 2. Description of the Related Art

Individuals, businesses, institutions, such as hotels and the like, display art work in their living environments. While some of the artwork is original, much of it includes printed copies of original artwork. Frequently, such artwork is duplicated via printing on canvases or other substrates to give it an original “feel” to multiple copies. The printed artwork is then mounted and framed.

Framing artwork can be quite expensive when many copies are produced. For example, many hotels have over 500 rooms. When a hotel places four prints in each room, over 2,000 prints must be mounted and framed. The resulting cost just for the framing alone can be in the hundreds of thousands of dollars.

In the alternative, some prints are wrapped around a frame (such as a wooden frame or a stretching bar, also known as a backing frame) in what is referred to as a “stretched canvas” and/or a “gallery wrap.” In a gallery wrap, part of the print is wrapped around the sides of the frame. However, a gallery wrap does not lend itself well aesthetically to certain genres of prints. For example, many people do not want gallery wrapped prints of renaissance artwork, nature scenes and the like.

Therefore, there is a need for a process for presenting an image of framed artwork without incurring the cost of framing.

### SUMMARY OF THE INVENTION

The disadvantages of the prior art are overcome by the present invention which, in one aspect, is a method of generating a print, in which an image of at least one work of art is scanned, thereby generating a digital image of the artwork. An image of at least one frame molding is scanned, thereby generating a digital image of the molding. The artwork digital image is combined with the molding digital image, thereby generating a combined image of the work of art surrounded by a frame made of the molding. The combined image is printed onto a substrate.

In another aspect, the invention is a system for generating printed artwork that includes an art scanner that is configured to multi-dimensionally scan works of art, thereby generating digital artwork images thereof. A molding scanner is configured to multi-dimensionally scan moldings, thereby generating digital molding images thereof. A computer is programmed to combine at least one of the digital artwork images with at least one digital molding image, thereby generating a combined digital image that include an image of one of the works of art surrounded by an image of a frame made from one of the moldings. A printer prints in multiple dimensions the combined digital image onto a selected substrate.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1A is a schematic diagram of a molding scanning system.

FIG. 2 is a schematic diagram of an artwork scanning system.

FIG. 3 is a schematic diagram of a combined image printing system.

FIGS. 4A-4D are schematic diagrams showing digital images of moldings/mattes being assembled into an image of a frame.

FIGS. 5A-5E are schematic diagrams showing a process of selecting artwork images, moldings/mattes, substrates and combining them onto a final digital file for sale or print.

FIG. 6 is a flowchart showing one method of generating prints that include the image of a frame.

FIGS. 7A-7D are schematic diagrams demonstrating a method of printing a frame image onto any material applied adhesively, such as tape and then applying the material to an artwork, print or original.

FIG. 8 is a schematic diagram of an embodiment in which a frame image is printed onto a mirror or other reflective surface.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” As used herein, “artwork” includes any tangible aesthetic expression of authorship, examples of which include: paintings, drawings, sketches, photographs, prints, sculptural works, etc.

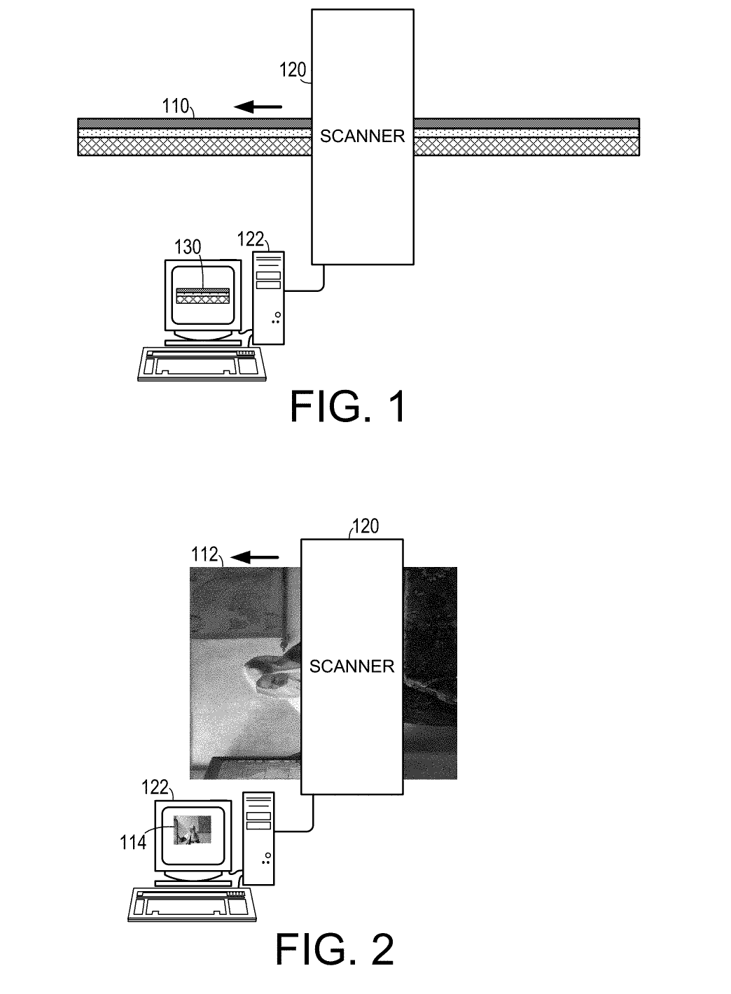

As shown in FIG. 1, in one embodiment of the invention, a scanner 120, which is in data communication with a computer 122 that includes a non-volatile memory and a display device, is used to scan a piece of molding 110 of the type that is typically employed in a picture frame and stores a digital image 130 of the molding 110. The scanner 120 can also scan a matte board, including a beveled matte. In one embodiment, the scanner 120 senses and records two or three dimensional information about the molding 110.

As shown in FIG. 2, the scanner 120 also scans at least one original work of art 112 and stores a digital image 114 of the work of art 112. In one embodiment, the scanner 120 can sense and store two- or three-dimensional information about the work of art 112, which would indicate the texture of brush strokes and the like. There is no requirement that the scanner used to scan the molding be the same scanner used to scan the work of art.

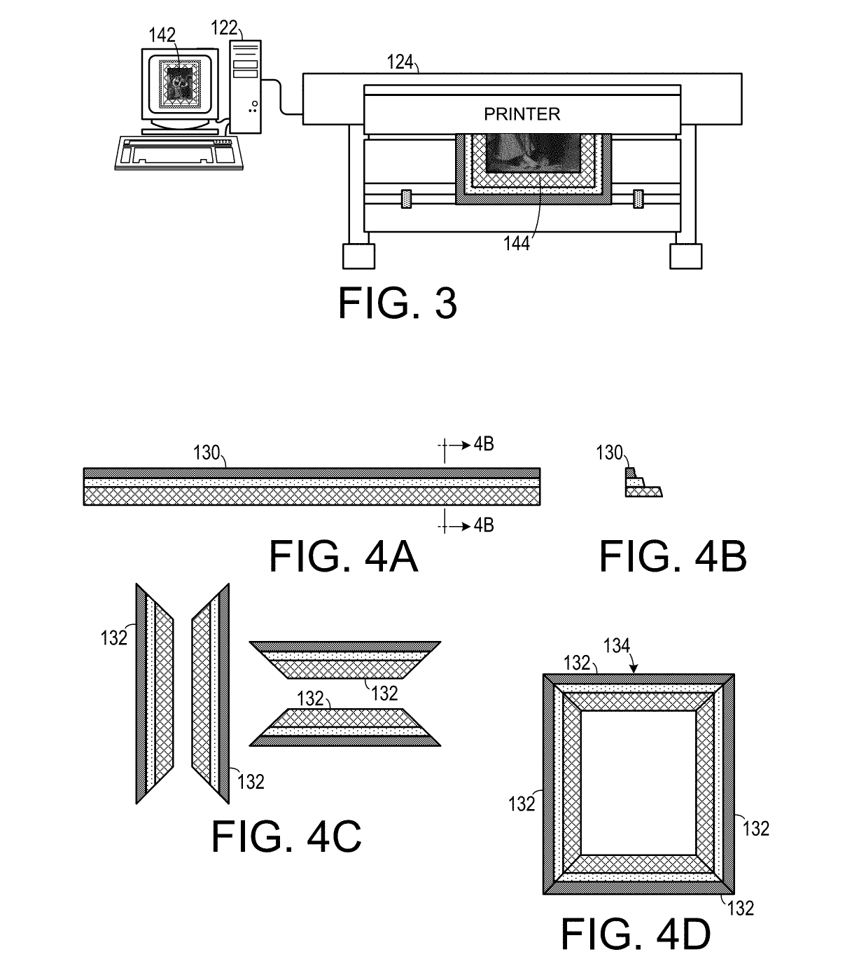

As shown in FIG. 3, the computer 122 combines the digital image of the artwork with the digital image of the molding (and any matte material that is desired) into a combined image 142. (It should be noted that the digital images need not have been sourced from scanning only.) The combined image is printed onto a substrate with a printer 124 (such as an ink jet printer) to generate an image 144 that appears to be framed. The substrate can be one of many different materials, depending upon the specific application. For example, the substrate could include: a flexible canvas material, a rigid plastic, a flexible plastic, a metal, a wood product, a fiberboard, a glass material, a mirror, etc. If the printer is a three dimensional printer, it can print the frame in relief and can also print the texture of the brush strokes in the art work.

As shown in FIGS. 4A-4D, the scanned molding 130 (which can be a three dimensional image, as shown in FIG. 4B) can be manipulated by the computer to generate a plurality of molding segments 132, each having a length that corresponds to the outer edges of the work of art. The segments 132 are then assembled to form a frame image 134. In certain embodiments, the molding images can be sourced from a non-scanned image source.

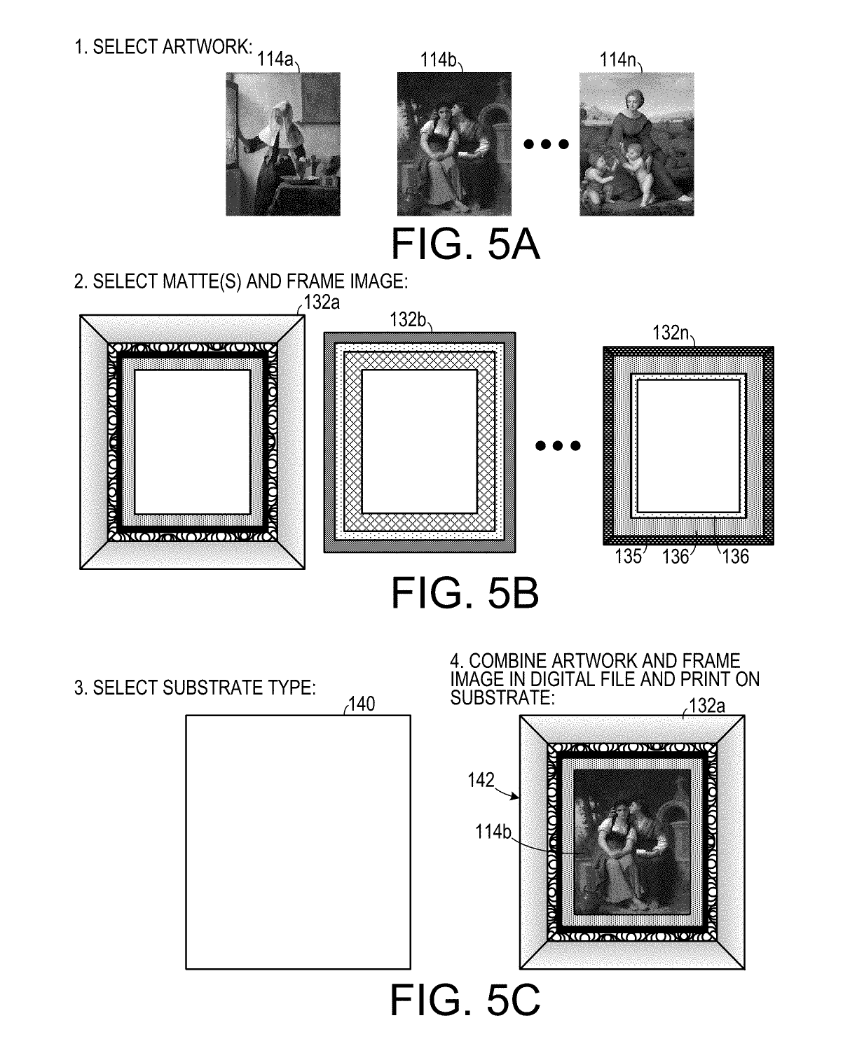

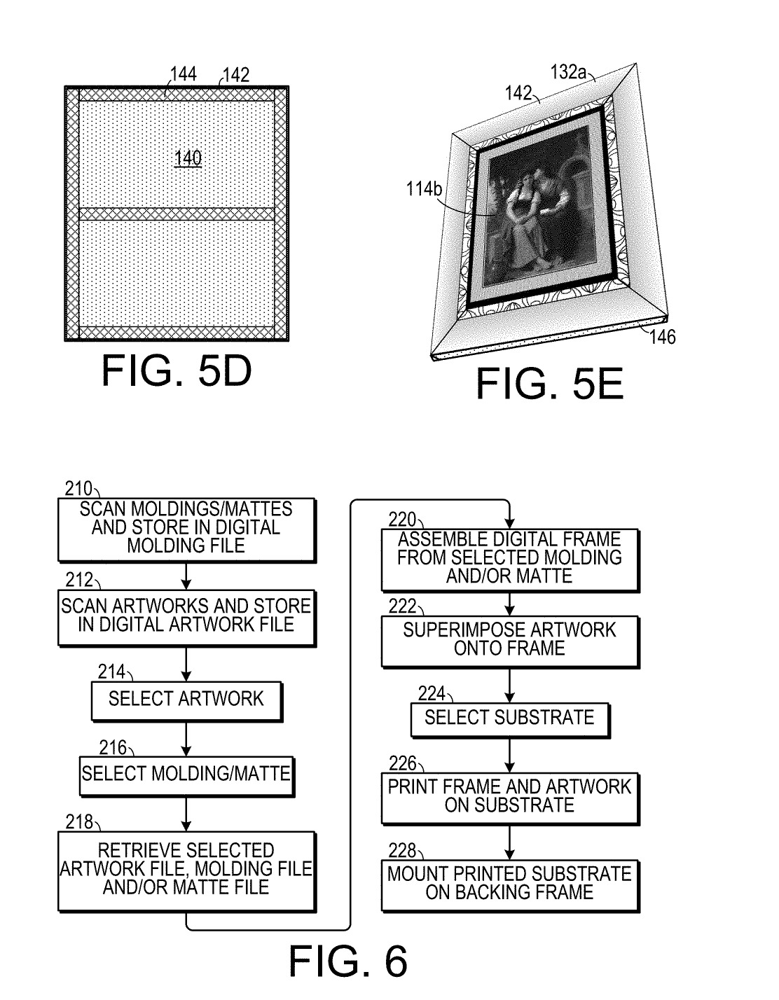

In one practical embodiment, a user selects from several different digital images 114a-n of works of art, as shown in FIG. 5A. The user also selects from different frame styles 132a-n, as shown in FIG. 5B. The frame style may include the image of at least one molding 135 and one or more matte styles 136 (which can include beveled mattes). As shown in FIG. 5C, the desired substrate type 140 is selected. The selected artwork image 114b and the selected frame/matte image 132a are printed onto the substrate to generate the print 142.

As shown in FIG. 5D, the print 142 can be mounted on a frame 144, such as a wood frame, if the substrate 140 is made of a flexible material. This results in a print 142 that appears to be a framed work of art ready for display, as shown in FIG. 5E.

As shown in FIG. 6, in one method for generating a framed print, of the type disclosed above, moldings and mattes are scanned and stored in a digital file 210. In certain embodiments, they can be imported, sourced or digitally created. Works of art, such as paintings and the like, are scanned and stored in a digital file 212. The user selects an artwork 214 and a combination of molding and mattes 216. The digital images of the artwork, the molding and mattes are retrieved 218 from memory. The molding and any desired mattes images are assembled to generate an image of a frame 220, which is superimposed onto the image of the artwork 222 and stored in a combined image file. The substrate is selected 224 and the combined image is printed on the substrate 226 resulting in the final print. The final print is then stretched and/or mounted, if necessary, onto a backing frame 228. (It will be understood that when the images are printed on certain substrates, such as rigid substrates, the backing frame may not be necessary.)

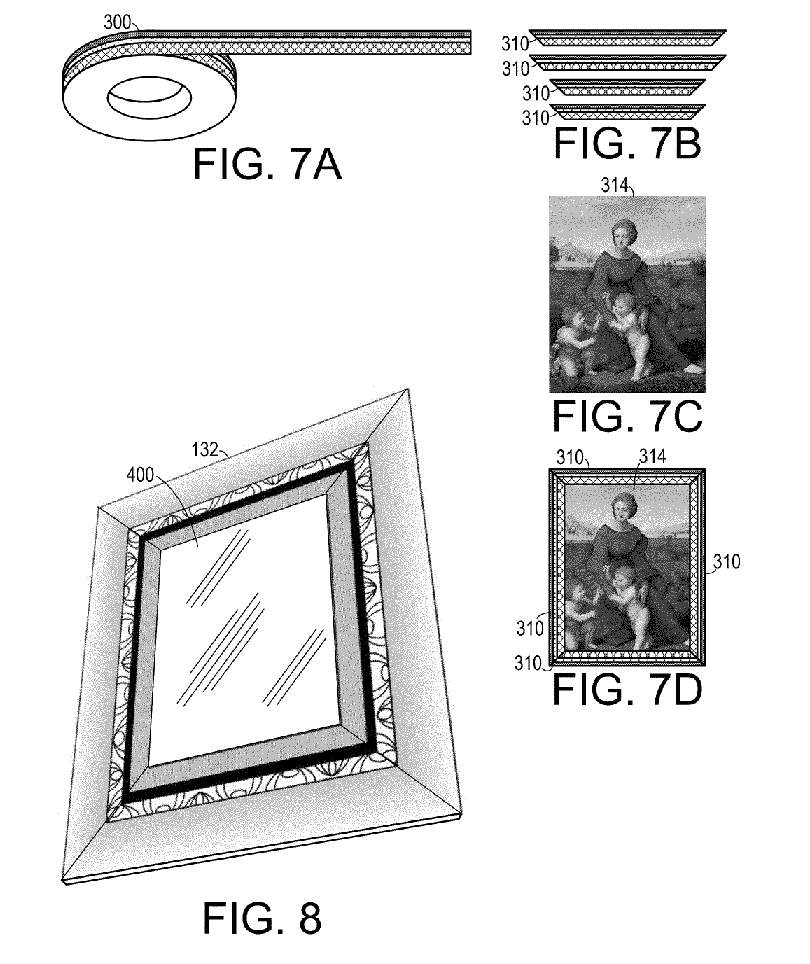

In one embodiment, as shown in FIG. 7A, the moldings and any desired mattes can be printed on a roll of spooled substrate 300. As shown in FIG. 7B, framing segments 310 can be cut from the roll of spooled substrate 300 and applied or affixed to an existing original work or print 314, as shown in FIG. 7C, thereby giving the existing original work or print 314 a framed look, as shown in FIG. 7D. In one embodiment, the molding image may be printed on a tape to which an adhesive (such as a pressure-sensitive adhesive) may subsequently be applied.

As shown in FIG. 8, in one embodiment, a frame image 132 can be printed on a glossy object, or a reflective surface such as a mirror 400, thereby giving the mirror 400 a framed appearance.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A method of generating a print, comprising the steps of:
(a) scanning an image of at least one work of art, thereby generating an artwork digital image, or importing existing digital artwork images;
(b) scanning an image of at least one frame molding, thereby generating a molding digital image, or importing existing digital molding images;
(c) combining the artwork digital image with the molding digital image thereby generating a combined image of the work of art surrounded by a frame made of the molding; and
(d) printing the combined image onto a substrate.

2. The method of claim 1, wherein the step of scanning an image of at least one frame molding includes the step of scanning two or three dimensional information from the frame molding.

3. The method of claim 1, wherein the step of printing the combined image onto a substrate includes printing in two or three dimensions.

4. The method of claim 1, further comprising the step of scanning at least one matte, thereby generating a matte digital image, wherein the combining step further comprises combining the matte digital image to the combined image.

5. The method of claim 1, wherein the substrate comprises at least a selected one of: a flexible canvas material, a rigid plastic, a metal, a wood product, a fiber board, a glass material, a mirror, paper products and a tape.

6. A system for generating printed artwork, comprising:
(a) an art scanner that is configured to scan works of art, thereby generating digital artwork images thereof;
(b) a molding scanner that is configured to scan moldings, thereby generating digital molding images thereof;
(c) a computer that is programmed to combine at least one of the digital artwork images with at least one digital molding image, both of which need not originate from the aforementioned steps, thereby generating a combined digital image that include an image of one of the works of art surrounded by an image of a frame made from one of the moldings; and
(d) a printer that prints the combined digital image onto a selected substrate.

7. The system of claim 6, further comprising a matte scanner that is configured to scan mattes, thereby generating digital matte images thereof, wherein the computer is further programmed to add an image of one or multiple mattes to the combined image.

8. The system of claim 7, wherein at least one of the art scanner, the molding scanner and the matte scanner includes a capability to sense and store information from two or three dimensions.

9. The system of claim 8, wherein the printer has two or three dimensional printing ability so that it prints a two or three dimensional image onto the substrate.

10. The system of claim 6, wherein the printer comprises an ink jet printer.

11. The system of claim 6, wherein the substrate comprises at least a selected one of: a flexible canvas material, a rigid plastic, a metal, a wood product, a fiber board, a glass material, a mirror, paper products and a tape.
